(19) United States
(12) Patent Application Publication
(10) Pub. No.: US 2005/0221825 A1
(43) Pub. Date: Oct. 6, 2005

(54) Mobile telecommunication system capable of executing handover and relocation involving plural radio network controllers (RNC) without using lur interface

(75) Inventor: Shinya Osugi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/086,348

(22) Filed: Mar. 23, 2005

(30) Foreign Application Priority Data
Mar. 31, 2004 (JP) 2004-107143

(51) Int. Cl. H04Q 7/20

(52) U.S. Cl. 455/436

(57) ABSTRACT

Disclosed is the mobile telecommunications system, which allows performing handover involving plural RNCs without using the lur interface in a mobile telecommunications system having a RAN that is converted to be compliant with the IP. When the measured value of the received power supplied from Node B 203 assigned to RNC 302 increases as a result of the movement of UE 101 and the difference in the above received power from the received power supplied from Node B 202 exceeds a preset threshold for a determined time interval, RNC 301 requests the base station information about Node B 203 to RNC 302 which manages Node B 203, and acquires it. RNC 301, when receiving the base station information from RNC 302, directly controls Node B 203 through the use of the received base station information and executes handover of UE 101 from the cell of Node B 202 to the cell of Node B 203.

### BACKGROUND OF THE INVENTION

1. Field of the Invention

The present invention relates to a mobile telecommunications system provided with at least one mobile station (UE, User Equipment), a plurality of radio base stations (Node-B), a plurality of radio network controllers (RNC) adapted to manage the plurality of radio base stations (Node-B), and particularly to a method of controlling handover for switching a radio base station with which a radio connection of a mobile station is established, as the mobile station moves.

2. Description of the Related Art

Recently, mobile telecommunication systems as represented by portable telephone systems have been widely used. The mobile telecommunication system has typically been composed of at least one mobile station, a plurality of radio base stations, radio network controllers adapted to control the plurality of radio base stations, and a core network (CN) connected with the radio network controllers through wired connections.

In this mobile telecommunications system, each radio network controller has predetermined radio base stations assigned as objects to be controlled. When a mobile station moves from a cell of a radio base station to a cell of another radio base station, if the two radio base stations are assigned under the management of an identical radio network controller, then it needs only to execute handover under the management of the relevant radio network controller. If, however, the two radio base stations are placed under the management of different radio network controllers, then it needs to transfer the control information to maintain the on-going radio connection with the mobile station, to the management of the different radio network controller. The procedure of transferring the authority to manage a mobile station between radio network controllers as described above is called “relocation.”

In the conventional mobile telecommunications system, the ATM (Asynchronous Transfer Mode) network has been used as a RAN (Radio Access Network) for signaling between a radio base station and a radio network controller and between radio network controllers.

The ATM network has well-developed traffic management and quality control capabilities for traffic having various characteristics and is a useful technique for providing not only a circuit switch service but also a packet switch service. Thus, the ATM offers a great advantage of realizing these circuit switch service and packet switch service in the same architecture, enabling comprehensive coordination of quality control and operation, etc. In addition, the ATM has been adapted for a RAN (Radio Access Network) in 3 GPP (3rd Generation Partnership Project) Release 99 and further, the ATM network has been widely used in the RAN of the CDMA mobile telecommunications system in which the CDMA (Code Division Multiple Access) communication system has been adopted as a communication system, as described in the documents below.

Document 1: JP 2001-352570

Document 2: JP 2002-64849

This conventional CDMA mobile telecommunications system, referring to FIG. 1, comprises at least one mobile station (UE) 101, radio base stations (Node B) 901 through 904, radio network controllers (RNC) 801, 802 and core network (CN) 401.

However, in the case where the ATM network is employed for the RAN of a mobile telecommunications system, a problem encountered has been that the ATM line has to be laid throughout to cover a wide area, which entails high installation and high operation costs. For this reason, the radio network controllers (RNC) and the radio base stations (Node B) are connected as a dependent group in which a dependence relationship between a radio network controller (RNC) and radio base stations (Node B), that cannot be changed, is set up in advance. For example, in FIG. 1, radio base stations 901, 902 are connected exclusively with RNC 801 through the lub interface and prohibited from direct signaling of information with RNC 802. As a result, it has been specified that the diversity handover between RNCs (the process by which a radio connection of a mobile station is switched (handed) over from one base station assigned to one RNC to another base station assigned to another RNC) should be effected through the use of the lur interface for linking a RNC to another RNC.

In the field of fixed networks, conversion to comply with the IP (Internet Protocol) has been progressing, and with the explosive development of the IP communication scheme, diversification of service has been progressing. In view of the above-described recent trend, it is anticipated that RAN will be converted to the IP-compliant network (IP network) for the purpose of increasing affinity with an IP network and reducing running cost. If conversion of the RAN to the IP network is achieved, it will allow the connections between RNCs and radio base stations (Node B) to be effected as a complete group, in which any element included in the group can signal information directly to one other simply if the IP address and port number are known.

Even if the IP network is used as RAN, however, each RNC would need to store too much information, provided that the network is structured such that each RNC has information about all the radio base stations (Node B), such as IP address etc. For this reason, even if an IP network is used as the RAN, radio base stations (Node B) that are to be managed by each RNC, would still need to be fixedly assigned in advance. Consequently, simply applying the IP network to the RANs only leads to the result that the diversity handover between RNCs is effected via the lur interface, just like the case of using an ATM network for the RAN. For example, in the case where the conventional mobile telecommunications system shown in FIG. 1 is employed, when mobile station 101 moves from the cell of radio base station 902 to the cell of radio base station 903, RNC 801 has to communicate information with radio base station 903 via RNC 802.

However, a RNC should be able to establish communication directly with any radio base stations (Node B) in principle, because the RNCs and radio base station (Node B) constitutes a complete group as a result of the RAN being converted to the IP network. Notwithstanding the conversion of the RAN into the IP network, the diversity handover between RNCs is performed via the lur interface, just like the conventional handover method, and involves not only signaling via one more node but also signaling not via an optimum route, thereby potentially causing delay and quality degradation of the signaling.

### SUMMARY OF THE INVENTION

It is an object of the present invention to provide a method of controlling handover that enables performing handover involving plural RNCs (handover in which plural RNCs participate) without using the lur interface in a mobile telecommunication system in which a RAN is converted to an IP network.

In order to attain the above object, the present invention is intended as a method of controlling handover in a mobile telecommunications system for switching a radio connection to a radio base station that establishes a radio connection as a mobile station moves, said mobile telecommunications system having at least one mobile station, a plurality of radio base stations and a plurality of radio network controllers for managing said plurality of radio base stations, said radio base stations and said radio network controllers being connected through the IP network, comprising steps of;
said mobile station transmitting a quality measurement report for notifying the state of received power to a first radio network controller through a first radio base station if, as a result of the movement of said mobile station that is in an established radio connection with said first radio base station assigned to said first radio network controller, the received power, supplied from a second radio base station assigned to a second radio network controller other than said first radio network controller and measured in said mobile station, becomes higher than the received power, supplied from said first radio base station and measured in said mobile station, and comes to have the state of received power such that the difference exceeds a preset threshold,
said first radio network controller, when receiving said quality measurement report from said mobile station, transmitting a request for acquiring base station information about said second radio base station to said second radio network controller that manages said second radio base station,
said second radio network controller, when receiving said request for acquiring base station information, transmitting the base station information about said second radio base station stored in said second radio network controller in advance to said first radio network controller; and
said first radio network controller, when receiving the relevant base station information, performing handover of said mobile station from the cell covered by said first radio base station to the cell covered by said second radio base station, directly controlling said second radio base station through making use of the received base station information.

According to the present invention, it becomes feasible for the first radio network controller directly to control the second radio base station without intervention of the second radio network controller by using the base station information received from the second radio network controller such as the IP address/port number of the second radio base station, the bearer setup information, etc. As a result, in a mobile telecommunications system provided with a RAN that is converted to be compliant with the IP as well, the handover involving radio network controllers (RNCs) can be achieved without necessitating the lur interface.

It is feasible that said first radio network controller executes the relocation to transfer the authority to control said mobile station to said second or other radio network controller in the case that said mobile station is in connection exclusively with said second radio base station assigned to said second radio network controller. Further, it is feasible that said first radio network controller executes the relocation to transfer the authority to control said mobile station to the second or other radio network controller taking into allowance at least one of the following information items, including the state of the IP line, the state of traffic, the degree of delay, and the number of routers through which an IP packet passes, in addition to the fact that said mobile station is in connection exclusively with said second radio base station assigned to said second radio network controller.

According to the present invention, it is enabled to prevent the disconnection of a call and the degradation of a quality by determining the state of the IP line at the destination RNC. Further, it is feasible to obviate the degradation of service quality by performing relocation in order from the call of the highest priority such as a call in the course of a real time service. Furthermore, it is feasible to increase the number of accepted calls of the overall system by performing the relocation of the present embodiment even when the number of calls exceeds a permissible value on account of the acceptance of a new call request and a newly incoming call.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram representing the structure of a conventional mobile telecommunications system;

FIG. 2 is a block diagram representing the structure of the mobile telecommunications system of the first embodiment according to the present invention;

FIG. 3 is a diagram representing the operation of the mobile telecommunications system shown in FIG. 2;

FIG. 4 is a sequence chart illustrating the operation when RNC 301 retrieves the information about radio base station 203 from RNC 302;

FIG. 5 is a diagram illustrating the operation of the mobile telecommunications system shown in FIG. 2;

FIG. 6 is a diagram illustrating the operation of the mobile telecommunications system shown in FIG. 2;

FIG. 7 is a diagram illustrating the operation of the mobile telecommunications system shown in FIG. 2;

FIG. 8 is a diagram illustrating the operation of the mobile telecommunications system shown in FIG. 2; and

FIG. 9 is a block diagram representing the structure of the mobile telecommunications system of the second embodiment according to the present invention.

### DETAILED DESCRIPTION OF THE PREFERRED EMBODIMENT

### First Embodiment

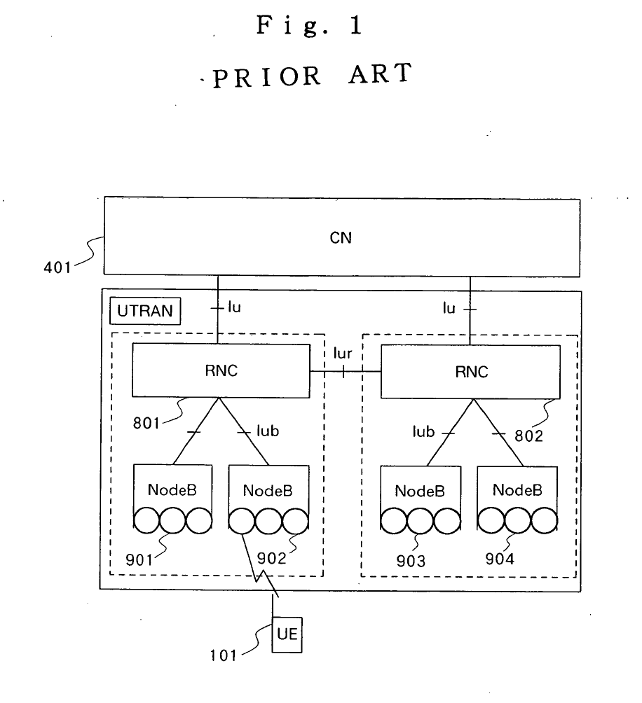

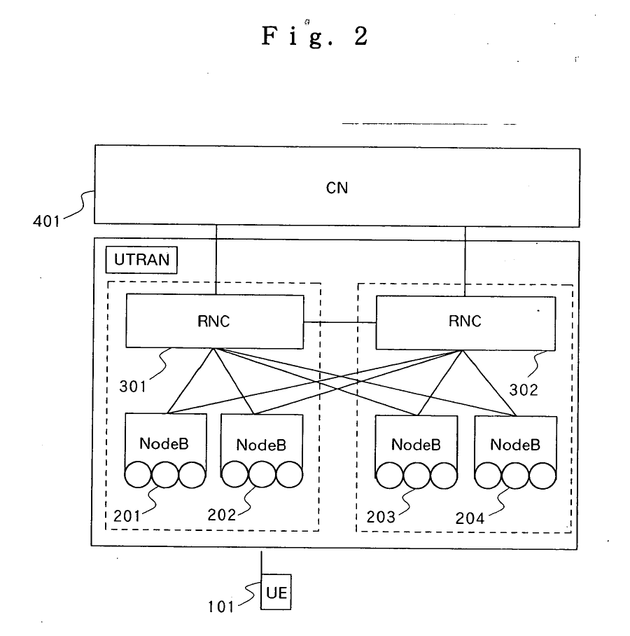

FIG. 2 is a block diagram illustrating the structure of the mobile telecommunications system of a first embodiment according to the present invention. In FIG. 2, the constituent elements that are identical with those shown in FIG. 1 bear the same reference numerals and the explanation thereof is omitted.

With reference to FIG. 2, the mobile telecommunications system of the present embodiment comprises mobile station (UE) 101, radio base stations (Node B) 201 to 204, radio network controllers (RNC) 301, 302 and core network (CN) 401.

The present embodiment provides a method of handover and relocation in the case where a RAN is converted into an IP network and thus RNCs and radio base stations (Node B) are in the complete-group relationship (RNCs and radio base stations (Node B) constitute a complete group.)

In the mobile telecommunications system of the present embodiment, because the RAN (Radio Access Network) that connects RNCs and radio base stations (Node B) is made compliant with the IP, it is feasible simultaneously to communicate information directly between any of RNCs 301, 302 and any of radio base stations 201 to 204, as shown in FIG. 2.

However, also in the present embodiment, radio base stations 201, 202 are placed under the management of RNC 301, which in advance holds base station information such as the IP addresses etc. exclusively of radio base stations 201 and 202, and radio base stations 203, 204 are placed under the management of RNC 302, which in advance holds base station information such as the IP addresses etc. exclusively of radio base stations 203 and 204.

For reference, while in the present embodiment, explanation is given using only two RNCs 301, 302 in order to simplify the description, more RNCs are connected to CN 401 in actual practice.

Mobile station 101 moves in radio areas provided by radio base stations 201 to 203, wherein mobile station 101 has the capability of measuring the received power on the CPICH (Common Pilot Channel) from radio base stations 201 to 204 and reporting the measured result to RNCs 301 and 302.

Each of radio base stations 201 to 204 has the capability of making a wireless communication connection with mobile station 101 and a wired communication connection with RNCs 301, 302 and communicating a signal.

Each of RNCs 301, 302 has the capability of deciding which RNC to which the radio base station, in connection with the relevant mobile station, is assigned, based on the list of Active Set of mobile station 101. Each of RNCs 301, 302 is capable of measuring the delay time of an acquired IP packet and the number of routers that the packet has been routed through, based on the content of the acquired IP packet. Each of RNCs 301, 302 determines the conditions of the IP line between the relevant RNC and radio base stations (Node B) assigned thereto by monitoring the IP line conditions or by receiving reports about the line conditions, and is capable of communicating the resource situations such as the possibility of permitting a new call to transfer simultaneously between the RNCs and communicating the information about the conditions of the IP line between the relevant RNC and the radio base stations assigned thereto. Each of RNCs 301, 302 has the capability of acquiring priority from the service type in the header information in the acquired IP packet and executing processes in accordance with the priority. Each of RNCs 301, 302 has, as a conventional capability, a capability of determining which radio base station (Node B) the mobile station (UE) is to be connected to, on the basis of a quality report transmitted from the mobile station (UE) and executing selection and combination of the uplink data and replication and distribution of the downlink data through multiple paths, when performing diversity handover in a two branch state.

Core network (CN) 401 is capable of executing a wired communication connection with RNCs 301, 302.

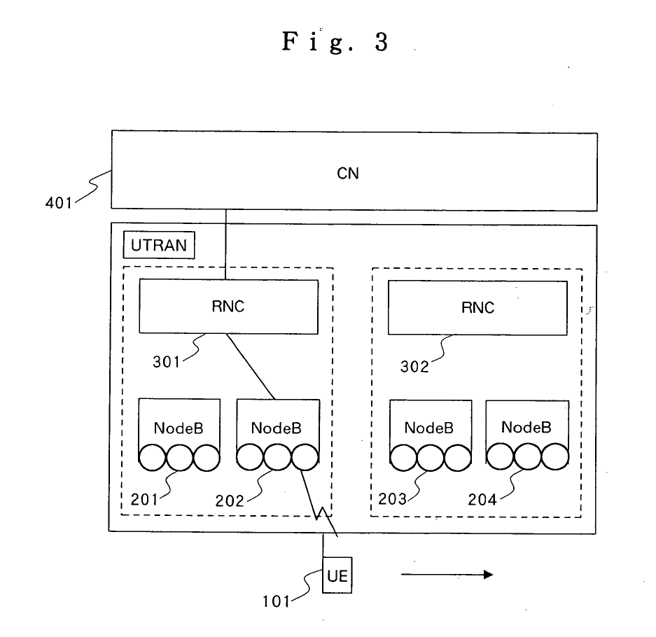

Explanation is next presented regarding the handover and relocation operations involving plural RNCs referring to FIG. 3 to FIG. 6.

First, in FIG. 3, it is presumed that mobile station 101 is in call and data communication states in the cell (radio area) provided by radio base station 202 and is under the control of RNC 301. In this case, RNC 301 functions as a serving RNC for mobile station 101.

In FIG. 3, it is further presumed that mobile station 101 moves toward the cell (radio area) provided by radio base station 203, which is assigned to RNC 302, keeping one branch state. On this occasion, as mobile station 101 approaches the cell boundary of radio base station 202, the received power, measured at mobile station 101, of the CPICH transmitted from radio base station 202 decreases and the received power from radio base station 203 gradually increases.

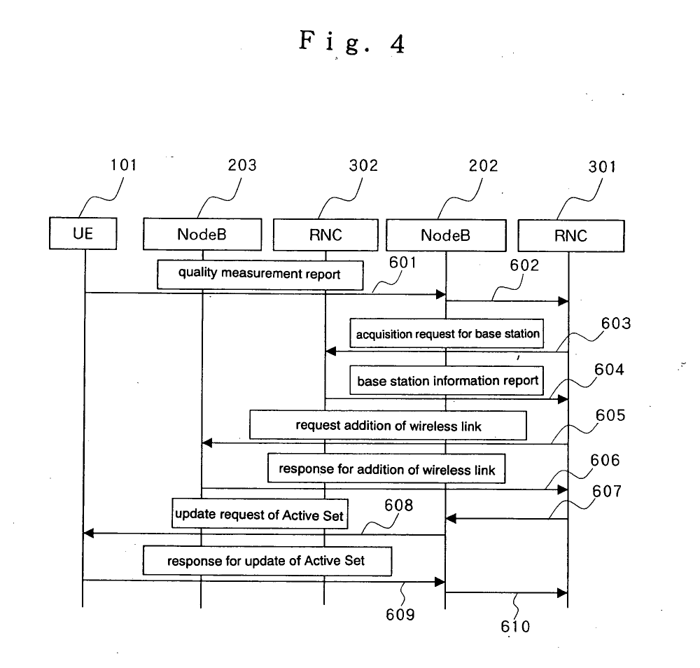

When the difference in the received powers of mobile station 101 transmitted from radio base stations 202 and 203 exceeds the preset threshold for a determined time, mobile station 101 sends RNC 301 a request for adding radio base stations 203 to Active Set. However, because radio base station 203 is not assigned to RNC 301, RNC 301 acts to retrieve the information about radio base stations 203 from RNC 302 in order to directly control radio base stations 203. FIG. 4 represents the sequence of this operation.

Referring to FIG. 4, when mobile station 101, which is in radio connection with radio base stations 202 assigned to RNC 301, moves, the received power transmitted from radio base stations 203 assigned to RNC 302 and measured in mobile station 101, increases. When the difference between the received powers from radio base stations 202 and 203 exceeds a preset threshold for a determined time interval, mobile station 101 transmits a quality measurement report via radio base stations 202 to report the fact to RNC 301 (Step 601, 602).

Then, RNC 301, which receives the quality measurement report from mobile station 101, decides whether or not to add radio base stations 203 to Active Set, based on the content of the quality measurement report received from mobile station 101. If RNC 301 decides that it can add radio base station 203, then RNC 301 sends an acquisition request for base station information describing the requirement of base station information about radio base station 203, to RNC 302 that manages radio base stations 203 (Step 603.) RNC 302 that receives the acquisition request for base station information from RNC 301 transmits the base station information regarding radio base stations 203 stored in advance such as the IP address/port number of radio base station 203 and the information necessary for setting a bearer, etc. to RNC 301 (Step 604.) RNC 301 that receives the base station information from RNC 302, in turn, requests the addition of a wireless link to radio base stations 203 using the received base station information regarding radio base stations 203 (Step 605.) Radio base stations 203, on receiving the request for the addition of a wireless link from RNC 301, sends back a response for the addition of a wireless (Step 606.)

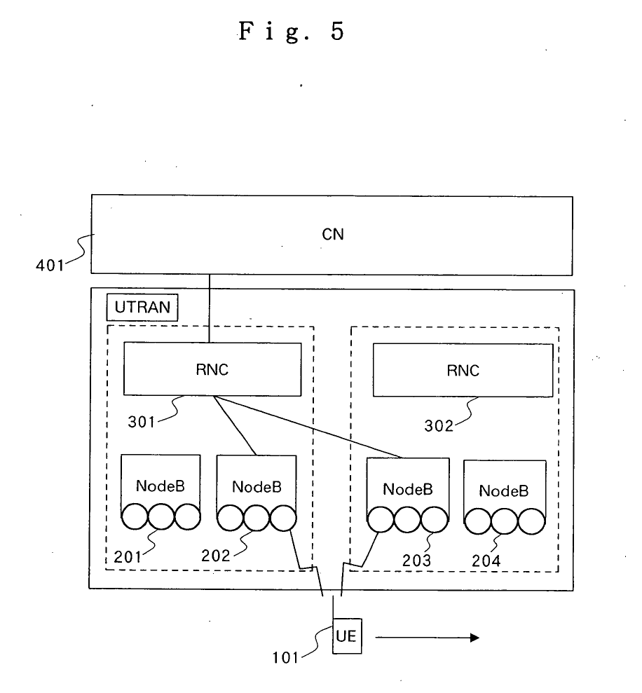

RNC 301, in addition, executes a request to update Active Set to mobile station 101 through radio base stations 202 (Step 607, 608) and mobile station 101 executes a response to update Active Set (Steps 609, 610), thereby entering the two-branch state as shown in FIG. 5.

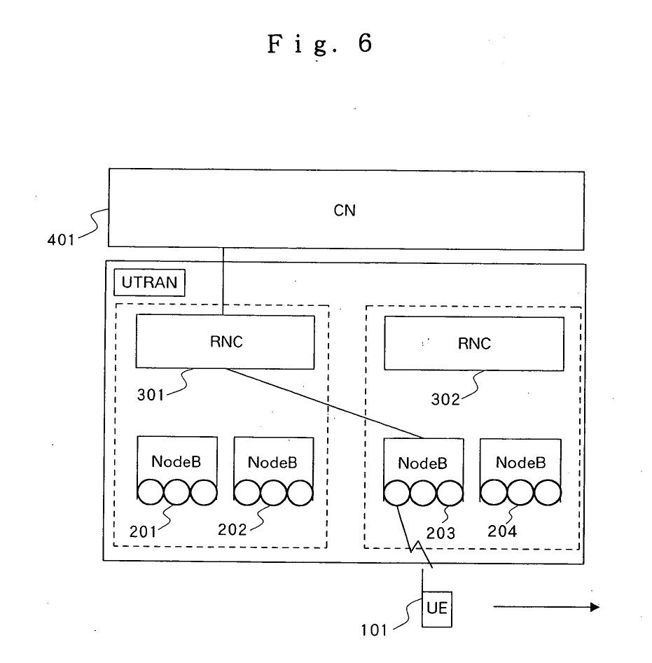

In the state shown in FIG. 5, as mobile station 101 moves away from the cell covered by radio base stations 202, the measured received power supplied from radio base stations 202 decreases. Then, when the received power decreases below a preset threshold for a determined time interval, mobile station 101 transmits the quality measurement report to RNC 301, which, based on the report, sends a request for canceling the wireless link to radio base stations 202. RNC 301 furthermore sends a request to mobile station 101 to update Active Set and cancel the connection branch established with radio base stations 202, and enters the one branch state, as shown in FIG. 6.

Thus, RNC 301, which has received the base station information from RNC 302, can execute the handover of mobile station 101 from the cell covered by radio base stations 202 to the cell covered by radio base stations 203 by directly controlling radio base stations 203 and by making use of the received base station information. Furthermore, in the IP-compliant RAN (the RAN made compliant with the IP), it is enabled to execute handover without using the lur interface by reading the information about the radio base station assigned to another RNC, as described above.

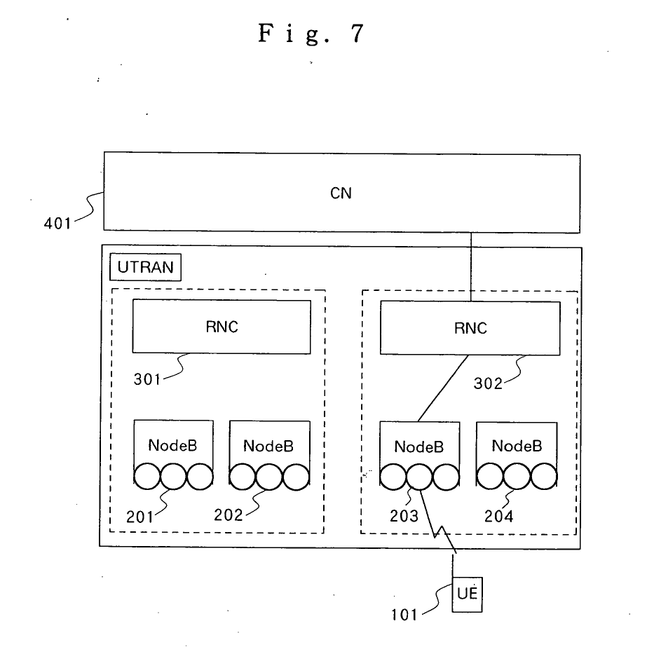

Next, when mobile station 101 moves to a location remote from the original radio area covered by radio base stations 201, 202 assigned to RNC 301, continuous control of RNC 301 over mobile station 101 will presumably cause the delay of user data and further cause prolonged travel of the IP packet on a transmission line which will make the IP packet fade away, thereby causing degradation of the quality of the transmission. Furthermore, RNC 301 is limited in the permissible number of calls it can use. As a result, a problem encountered will be that newly permissible number of calls and the calls newly to be entered into the control of RNC 301 decrease by the number of calls that correspond to the resources used for mobile station 101 moving in the coverage assigned to the RNC 302. For this reason, it is necessary to make an operation to relocate the control authority to an optimum RNC 302 from RNC 301 that has exercised continued control, as shown in FIG. 7. The authority to execute this relocation resides in RNC 301, which runs a relocation algorithm on the basis of several items of information. Executing this relocation gives RNC 302 the capability to act as a serving RNC for mobile station 101.

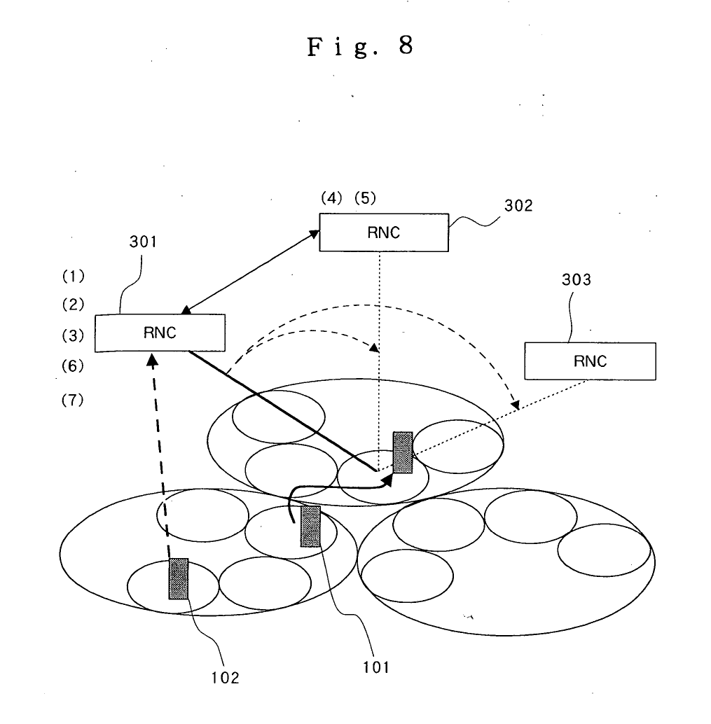

FIG. 8 represents the relation between the information used for the relocation algorithm and each RNC that measures the information. The information used for the relocation algorithm is: (1) the list of Active Set of mobile station 101; (2) the degree of the delay; (3) the number of the routers through which an IP packet has passed; (4) the state of the resources at the destination RNC; (5) the state of the destination IP line; (6) the priority of the calls that have experienced handovers; and (7) a new call request and an incoming call in RNC 301.

RNC 301 starts running the relocation algorithm for transferring the control authority over mobile station 101 in a situation when the event occurs that the list in Active Set of mobile station 101 includes one or more radio base stations exclusively assigned to another RNC, i.e., mobile station 101 connects exclusively with the radio base station assigned to another RNC (information (1).)

When RNC 301 starts running the relocation algorithm, RNC 301 begins measuring the delay time of user data and also measuring the number of the routers through which the packet passes based on the header of the relevant packet, (information (2) and (3).) When it is decided that the quality is problematic, the process proceeds to the next step. In the next step, the resource conditions representing whether or not a new call to destination RNC is permissible and the state of the IP line are retrieved (information (4) and (5)), and if it is decided that the relocation is permissible, then the relocation is executed. The retrieval of information (4) and (5) can be made through any one of direct inquiry to RNC 302 and the inquiry through core network (CN) 401. In addition, if there are plural calls that have made a transition to the state to run the relocation algorithm, the priority is decided by referring to the service type described in the IP header (information (7)) and the relocation is executed in accordance with the priority of respective calls.

If the number of calls to be managed by RNC 301 exceeds the permissible number as a result of the event that RNC 301 accepts a newly requested call, or a call newly enters the management area of RNC 301 (information (7)), the situations develops in which RNC 301 is unable to accept a call while a call is within a coverage area of a radio base station assigned to RNC 301. Consequently, the system-comprehensive permissible number of call connections decreases. In order to avoid such situations, the relocation algorithm is run to permit a new call. The destination in this relocation process is not necessarily limited to the RNC 302 that mobile station 101 is destined for, and if the destination RNC 302 cannot afford to permit the call, a similar relocation algorithm can be implemented to relocate to RNC 303 but not any of the RNCs 301 and 302.

For reference, it is permissible for RNC 301 to perform relocation based only on the decision that mobile station 101 is in connection with only the radio base station assigned to RNC 302. It is also permissible to perform relocation taking into account, in addition to the above decision, at least one of the information items about the degree of the delay, the number of the routers through which one packet passes, the resource conditions at the destination radio network controller, the state of the destination IP line, the priority of the calls that have experienced handovers and the information about new call requests and incoming calls in RNC 301.

According to the method of controlling handover in a mobile telecommunication system of the present invention, it become enabled for RNC 301 is enabled to directly control radio base stations 203 without going through RNC 302 by using the base station information such as the IP address/port number of radio base stations 203 and bearer setup information, etc., received from RNC 302. As a result, RNC 301 is enabled to perform handover involving RNCs without making use of the lur interface even in a mobile telecommunications system having an IP-compliant RAN.

Further, in a mobile telecommunications system having an IP-compliant RAN, realizing a handover without interposing the lur interface and the RNC relocation associated with the handover, makes it possible to prevent the delay of a packet. In addition, determining the situations of the IP line at the destination of the relocation enables the prevention of a breakage in a call and degradation of the quality. Further, starting performance of the relocation with a high priority call such as a call in the course of real time service, enables obviating degradation of the quality. Furthermore, if the number of calls exceeds a permissible quantity on account of a newly accepted call and a newly incoming call, performing the relocation described in the present embodiment can also increase the number of acceptable calls of the whole system.

### Second Embodiment

Explanation next is given regarding the mobile telecommunications system of the second embodiment according to the present invention. While the above-described mobile telecommunications system of the first embodiment regards the case in which a handover is conducted to switch a radio base station in order to establish a radio connection as a mobile station moves, the present embodiment regards the utilization of the relocation algorithm at the time of maintenance of a RNC.

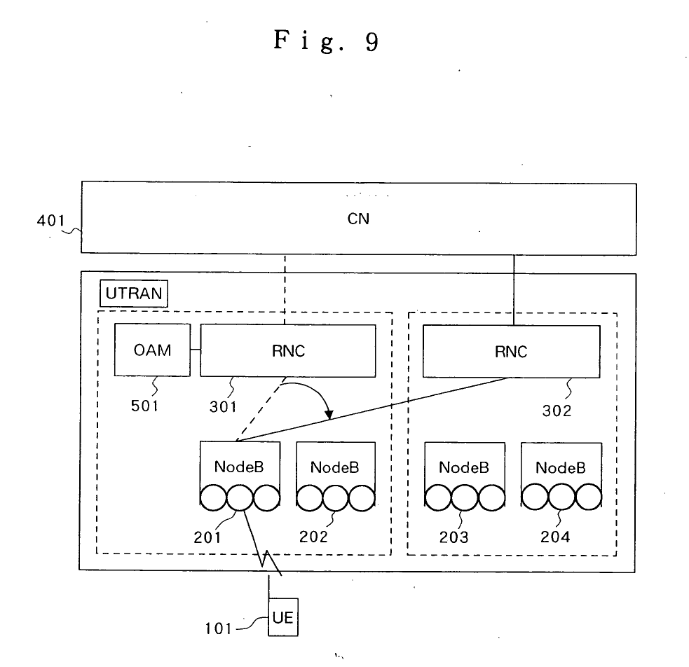

FIG. 9 illustrates the structure of the mobile telecommunications system of the present embodiment. The mobile telecommunications system of the present embodiment is configured such that OAM (Operation And Maintenance) device 501 is provided in addition to the mobile telecommunications system of the first embodiment shown in FIG. 2.

In the present embodiment, RNC 301 relocates the management of the calls that RNC 301 currently accepts to a peripheral RNC pursuant to the indication issued from OAM device 501. RNC 301, when receiving from OAM device 501 the indication to relocate the management of calls to another RNC, inquires about the state of the resources and the IP line to the peripheral RNCS, and if it is decided that RNC 302 can afford to permit a new call, then runs the relocation algorithm to transfer the authority to RNC 302 to control mobile station 101.

In this case, if the Active Set of mobile station 101 includes the radio base station assigned to another RNC, the relocation is made preferentially to the relevant RNC. In this way, executing the relocation to peripheral RNC 302, without cutting off all calls already having accepted to perform the maintenance of a RNC, waiting for linked calls to be exhausted, or preparing a backup system for the RNC to perform the maintenance, makes it feasible significantly to reduce the time required for maintenance.

For reference, the method of controlling a handover according to the present invention is limited neither to the configurations represented in the first and second embodiments nor to the order of the information items employed in the relocation algorithm. The relocation can be implemented without using all the information items. In addition, while the above first and second embodiments provide the method of handover and relocation in the case where the RNCs and radio base stations are in a complete group relationship in the RAN in compliance with the IP (the IP compliant RAN), the method of handover and relocation according to the present invention can be applied in other wired and wireless networks as well if the relations between the RNCs and radio base stations make up a complete group. If the IP is not used as protocol, the number of the router through which a package passes and the priority acquired from an IP header need not always be used.

Furthermore, the control method of the present invention can also be applied to the case where the resource and load of a RNC are needed for other processes and thus it is necessary to reduce calls already having been connected.

While preferred embodiments of the present invention have been described using specific terms, such description is for illustrative purposes only, and it is to be understood that changes and variations may be made without departing from the spirit or scope of the following claims.

1. A method of controlling handover in a mobile telecommunications system for switching a radio base station that establishes a radio connection, as a mobile station moves, said mobile telecommunications system having at least one mobile station, a plurality of radio base stations and a plurality of radio network controllers for managing said plurality of radio base stations, said radio base stations and said radio network controllers being connected through the IP network, comprising steps of;
said mobile station transmitting a quality measurement report for notifying the state of received power to a first radio network controller through a first radio base station if, as a result of the movement of said mobile station that is in an established radio connection with said first radio base station assigned to said first radio network controller, the received power, supplied from a second radio base station assigned to a second radio network controller other than said first radio network controller and measured in said mobile station, becomes higher than the received power, supplied from said first radio base station and measured in said mobile station, and comes to have said state of received power such that the difference of the two received powers exceeds a preset threshold,
said first radio network controller, when receiving said quality measurement report from said mobile station, transmitting a request for acquiring base station information about said second radio base station to said second radio network controller that manages said second radio base station,
said second radio network controller, when receiving said request for acquiring base station information, transmitting the base station information about said second radio base station stored in said second radio network controller in advance to said first radio network controller, and
said first radio network controller, when receiving the relevant base station information, performing handover of said mobile station from the cell covered by said first radio base station to the cell covered by said second radio base station, by directly controlling said second base station through making use of the received base station information.

2. A method of controlling handover in a mobile telecommunications system according to claim 1, including a step of said first radio network controller executing the relocation to transfer the authority to control said mobile station to said second radio network controller if said mobile station is in connection exclusively with said second radio base station assigned to said second radio network controller.

3. A method of controlling handover in a mobile telecommunications system according to claim 1, including a step of said first radio network controller executing the relocation to transfer the authority to control said mobile station to a radio network controller other than said first and second radio network controllers if said mobile station is in connection exclusively with said second radio base station assigned to said second radio network controller.

4. A method of controlling handover in a mobile telecommunications system according to claim 1, including a step of said first radio network controller executing the relocation to transfer the authority to control said mobile station to the second radio network controller taking into allowance at least one of the following information items, including the degree of delay, the number of routers through which an IP packet passes, the resource situations at the destination radio network controller, the state of the destination IP line, the priorities of the calls that have experienced handovers and the new call requests that have occurred in said first radio network controller and the calls that are incoming to the coverage of said first radio network controller in addition to the fact that said mobile station is in connection exclusively with said second radio base station assigned to said second radio network controller.

5. A method of controlling handover in a mobile telecommunications system according to claim 1, including a step of said first radio network controller executing the relocation to transfer the authority to control said mobile station to a radio network controller other than said first and second radio network controllers taking into allowance at least one of the following information items, including the degree of delay, the number of routers through which an IP packet passes, the resource situations at the destination radio network controller, the state of the destination IP line, the priorities of the calls that have experienced handovers and the new call requests that have occurred in said first radio network controller and the calls that are incoming to the coverage of said first radio network controller in addition to the fact that said mobile station is in connection exclusively with said second radio base station assigned to said second radio network controller.
